(19) United States
(12) Patent Application Publication
(10) Pub. No.: US 2026/0322208 A1
(43) Pub. Date: Oct. 15, 2026

(54) Rotor Shaft for an Electric Drive Motor, Electric Drive Motor, and Vehicle

(71) Applicant: Bayerische Motoren Werke Aktiengesellschaft, Muenchen (DE)

(72) Inventors: Jochen KRONSTEINER, St. Ulrich bei Steyr (AT); Andreas WAGNER, St. Valentin (AT)

(21) Appl. No.: 19/642,959

(22) Filed: Apr. 9, 2026

(30) Foreign Application Priority Data
Apr. 10, 2025 (DE) 10 2025 114 106.1

(51) Int. Cl. H02K 7/00; H02K 1/32

(52) U.S. Cl. CPC H02K 7/003; H02K 1/32

(57) ABSTRACT

A rotor shaft for an electric drive motor includes a hollow shaft that radially encloses a cavity, and a hollow lance that is arranged in the cavity and is fastened at both ends to the inside of the hollow shaft, wherein the lance has, in its circumferential wall, at least one opening, through which a coolant can flow from the lance into a region of the cavity that is delimited radially outwardly by the hollow shaft and radially inwardly by the lance.

### CROSS-REFERENCE TO RELATED APPLICATION

This application claims priority under 35 U.S.C. §119 from German Patent Application No. 10 2025 114 106.1, filed Apr. 10, 2025, the entire disclosure of which is herein expressly incorporated by reference.

### BACKGROUND AND SUMMARY

The present disclosure relates to a rotor shaft for an electric drive motor, to an electric drive machine for a motor vehicle, and to a motor vehicle.

WO 2023/280555 A1 discloses a coolant supply system for a drive device of an electrically operated motor vehicle. The coolant supply system comprises an electric machine, in the housing of which, on axially opposite housing walls, a hollow rotor shaft is rotatably mounted in bearing openings of the housing walls with interposed pivot bearings. The coolant supply system has, for internal rotor cooling, an electric machine hydraulic circuit with a coolant supply line, which feeds a coolant volumetric flow, in particular in an axial direction on an oil feed side, into the internal profile of the hollow rotor shaft such that the pivot bearing point located on the coolant feed side is able to be cooled radially from the inside. Provided in the hollow rotor shaft is a coolant path, which extends as far as the pivot bearing point located axially opposite the coolant feed side, such that the pivot bearing point located axially opposite the coolant feed side is additionally also able to be cooled radially from the inside. Incorporated into the coolant supply line is a tubular coolant lance, which projects into the internal profile of the hollow rotor shaft in the axial direction from the coolant feed side. The coolant lance delimits, together with the inner wall of the hollow rotor shaft, an annular gap through which coolant flows.

Furthermore, WO 2025/026637 A1 discloses an electric traction motor for a motor vehicle, having a stator, a rotor that is rotatable about an axis of rotation relative to the stator, a hollow rotor shaft, on which the rotor is fitted for conjoint rotation and inside which oil can be conducted, and having a housing enclosing the stator and the rotor. Arranged in the cavity of the rotor shaft is a lance that rotates conjointly with the rotor shaft and which is designed to conduct oil within the rotor shaft in the vicinity of the axis of rotation and back along an inner wall, delimiting the cavity, of the rotor shaft.

The present disclosure addresses the problem of creating a solution which allows a lance to be arranged within a rotor shaft particularly precisely.

This problem is solved according to the present disclosure. Further possible configurations are disclosed in the description and the figures. Feature, advantages and possible configurations that are set out in the description for one of the subjects of the present disclosure should be considered, at least analogously, as being features, advantages and possible configurations of the respective subjects of other portions of the present disclosure and of any possible combination of the subject matter disclosed herein .

The present disclosure relates to a rotor shaft for an electric drive motor. The electric drive motor is designed, in particular, to be used as a traction motor in a motor vehicle. Assistance system means that, by the electric drive motor, a motor vehicle can be electrically driven. In addition to the rotor shaft, the electric drive motor can comprise a rotor fitted for conjoint rotation on the rotor shaft, and a stator, relative to which the rotor shaft and the rotor can be rotated about an axis of rotation during operation. In the present case, the rotor shaft comprises a hollow shaft, which radially encloses a cavity. Furthermore, the rotor shaft comprises a hollow lance, which is arranged in the cavity and is fastened at both ends to the inside of the hollow shaft. The lance has, in its circumferential wall, at least one opening, through which a coolant can flow from the lance into a region of the cavity that is delimited radially outwardly by the hollow shaft and radially inwardly by the lance. The rotor shaft is, in particular, rotationally symmetric with the axis of rotation about which the rotor shaft can be rotated relative to the stator during operation. Provision is made for coolant to flow, by the lance or through the lance, into the rotor shaft or into the cavity enclosed by the hollow shaft. By the lance, the coolant can be conducted within the cavity or distributed within the cavity particularly precisely. By selecting an arrangement of the at least one opening in the lance, it is possible to precisely control how the coolant flows into the region between the lance and the inner wall, delimiting the cavity, of the hollow shaft, or how the coolant flows within the region between the outer side of the lance and the inner wall, delimiting the cavity, of the hollow shaft. As a result of the position of the at least one opening in the lance being chosen appropriately, it is possible for the rotor shaft to be able to be cooled particularly uniformly by the coolant during operation. As a result, the risk of local overheating of the rotor shaft and the risk of local overheating of the rotor fitted for conjoint rotation on the rotor shaft when used as intended can be avoided particularly readily. Since the lance is fastened at both ends to the inside of the hollow shaft, this means that the lance is held for conjoint rotation on the hollow shaft - and thus rotates about the axis of rotation together with the hollow shaft during operation - and this also means that the lance is fixed in position particularly securely within the cavity. Vibration of the lance, as could occur for example if the lance were fastened only at one end, can thus be avoided particularly readily. As a result of the lance being fastened at both ends to the inside of the hollow shaft, the lance is held particularly securely on the hollow shaft and fixed in position particularly securely within the cavity. It is thus possible for the coolant to be conducted particularly precisely within the cavity by the lance.

In one possible development of the present disclosure, provision is made for the lance to be open at a first end, with the result that, via this first end, the coolant can flow into a lance volume enclosed by the lance. Furthermore, provision may be made for the lance to be closed at its second end opposite to the first end. For example, the lance may be overlapped at its second end by an inner wall, delimiting the cavity, of the hollow shaft and be closed as a result. This prevents the coolant from flowing out at the second end of the lance. This makes it possible to ensure that the coolant flows out of the lance volume only through the at least one opening in the circumferential wall of the lance. Any flow of the coolant out of the lance volume bypassing the at least one opening arranged in the circumferential wall of the lance can thus be avoided particularly readily. Consequently, it is possible for the coolant to be conducted in the cavity particularly precisely by the lance.

In one possible configuration of the present disclosure, provision is made for the lance to be held at both ends against the inside of the hollow shaft in each case via a press fit. A press fit is a connecting technique in which two components are connected together by pressing action such that the two components, in the present case the lance and the hollow shaft, are joined together with an interference fit. In this case, the lance is pressed into the hollow shaft. Each of the ends of the lance forms a respective press fit with the hollow shaft. As a result, it is possible to ensure that each of the ends of the lance is held securely against the hollow shaft and, as a result, is fixed in position relative to the hollow shaft. The respective press fit allows the lance to be held particularly securely on the hollow shaft without further auxiliary material, for example adhesives, being used.

In a further possible configuration of the present disclosure, provision is made for the hollow shaft to have, at one of its ends, an external toothing, via which the hollow shaft can mesh with a transmission input shaft. Furthermore, provision is made for the lance to overlap the external toothing radially inwardly in a longitudinal portion. In particular, the lance has the press fit with the hollow shaft in the region in which the lance overlaps the external toothing of the hollow shaft radially inwardly. Via the external toothing, it is thus possible, in a longitudinal region of the hollow shaft, for the hollow shaft to mesh with the transmission input shaft and, at the same, to be connected to the lance via the press fit. A longitudinal portion of the hollow shaft can thus fulfill a particularly large number of different functions at the same time. Since the hollow shaft has the external toothing, via which the hollow shaft can mesh with the transmission input shaft, the lance can form the press fit with a surface of the hollow shaft, which is in particular smooth. As a result, the press fit can be formed particularly easily and securely.

In an alternative possible configuration of the present disclosure, provision is made for the hollow shaft to have, at one of its ends, an internal toothing, via which the hollow shaft can mesh with a transmission input shaft. In this case, provision is furthermore made for the lance to bears against the internal toothing in a longitudinal portion, with the result that the lance is held at one end against the hollow shaft via the internal toothing. In other words, the lance overlaps the internal toothing radially inwardly. The lance thus forms the press fit with respective teeth of the internal toothing of the hollow shaft. Since the rotor shaft has the internal toothing, via which the rotor shaft can mesh with the transmission input shaft, the transmission input shaft can be provided with a particularly small outside diameter, since, to mesh with the hollow shaft, the transmission input shaft is intended to be plugged into an opening in the hollow shaft in order to mesh with the internal toothing of the hollow shaft. Consequently, the transmission input shaft can be formed with a particularly low weight.

In a further possible configuration of the present disclosure, provision is made for the lance to be held by its first end against the hollow shaft via the internal toothing and for a sealing ring to be provided, which fully overlaps all gaps between the teeth of the internal toothing in an axial direction toward the second end of the lance and bears against the lance radially outwardly with its radially inner side. As a result, any flow of the coolant along the outer side of the lance through the gaps between the teeth of the internal toothing and into the region of the cavity which is delimited radially outwardly by the hollow shaft and radially inwardly by the lance is prevented. This avoids a situation in which the coolant, bypassing the lance volume, can flow into this region of the cavity which is delimited radially outwardly by the hollow shaft and radially inwardly by the lance. By he sealing ring, the gaps between the teeth of the internal toothing are thus sealed off toward the region of the cavity which is delimited radially outwardly by the hollow shaft and radially inwardly by the lance. Consequently, specific precise conduction of the coolant by the lance can be achieved.

In a further possible configuration of the present disclosure, provision is made for the at least one opening in the lance to be arranged so as to radially overlap a region of the hollow shaft which, when the rotor shaft is used as intended in the electric drive motor, is overlapped radially outwardly by an axial center of the rotor. In other words, provision is made for the at least one opening in the lance to overlap an axial center of the rotor, when the rotor shaft is used as intended in the electric drive motor, in a radial direction toward the axis of rotation. Thus, if the coolant flows in a radial direction out of the opening in the lance, this coolant flows directly against a region of the hollow shaft on which the axial center of the rotor sits. Particularly efficient cooling of a central region of the rotor can thus be effected when the rotor is fitted on the hollow shaft for conjoint rotation.

In a further possible configuration of the present disclosure, provision is made for the lance to have a cross-sectional narrowing downstream of the at least one opening in the direction of flow of the coolant through the lance. As a result of this cross-sectional narrowing, it is possible for the coolant to flow primarily out of the at least one opening in the lance and for the risk of the coolant bypassing the opening without the coolant flowing out of the opening to be kept particularly low. It is thus possible for the coolant flowing within the lance volume to flow reliably through the at least one opening in the lance, out of the lance volume and into the region of the cavity which is delimited radially outwardly by the hollow shaft and radially toward the axis of rotation by the lance.

The present disclosure also relates to an electric drive motor, in particular for a motor vehicle, having a stator, a rotor that is rotatable about an axis of rotation relative to the stator, and having a rotor shaft as has already been described in conjunction with the rotor shaft according to the present disclosure, on which the rotor is fitted for conjoint rotation. In particular, the electric drive motor is a radial flux motor. The configuration of the electric drive motor with the described rotor shaft according to the present disclosure allows particularly efficient cooling both of the rotor shaft and of the rotor, with the result that the electric drive motor can be operated particularly efficiently.

The present disclosure also relates to a motor vehicle, in particular a car, in particular a passenger car, having an electric drive motor as has already been described in conjunction with the electric drive motor according to the present disclosure. The electric drive motor is, in particular, a traction motor for the motor vehicle, which is designed to drive the motor vehicle by electrical energy.

Further features of the present disclosure will become apparent from the figures and the description of the figures. The features and combinations of features mentioned previously in the description and the features and combinations of features disclosed in the following description of the figures and/or shown only in the figures are usable not only in the respectively specified combination but also in other combinations or on their own without departing from the scope of the present disclosure.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic sectional view of a rotor and of a rotor shaft for an electric drive motor of a motor vehicle in a first embodiment, and

FIG. 2 shows a schematic sectional view of the rotor and of the rotor shaft for the electric drive motor in a second, alternative embodiment.

### DETAILED DESCRIPTION OF THE DRAWINGS

In the figures, identical and functionally identical elements are provided with the same reference signs.

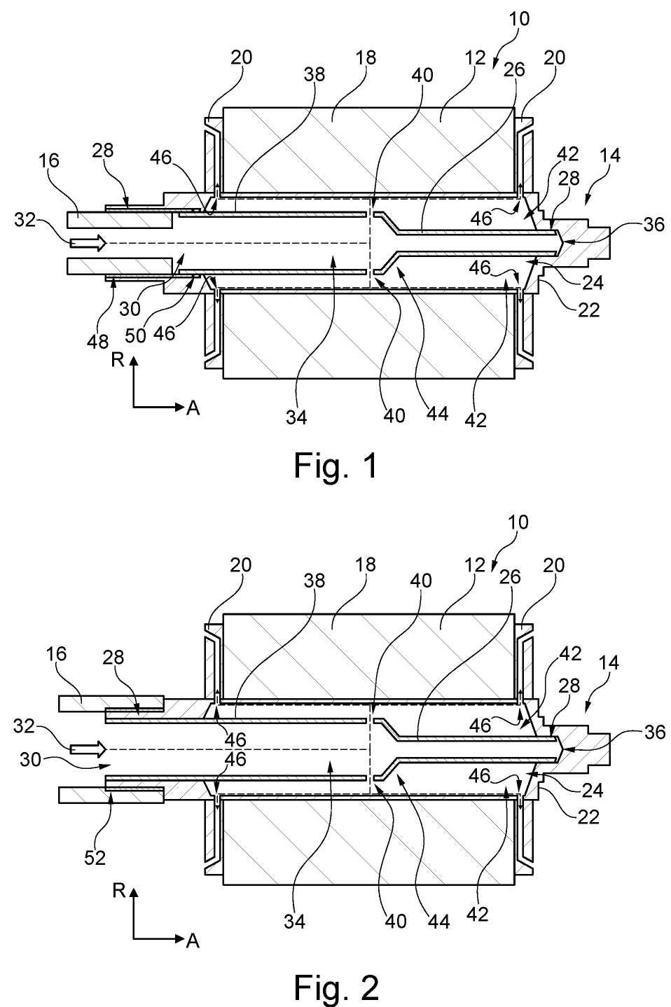

FIGS. 1 and 2 show respective schematic sectional views of an arrangement 10 comprising a rotor 12, a rotor shaft 14 and a transmission input shaft 16. The arrangement 10 is intended in particular to be part of an electric drive motor for a motor vehicle, in particular part of a radial flux motor. The rotor 12 is fitted on the rotor shaft 14 for conjoint rotation. The rotor 12 and the rotor shaft 14 are designed to be rotated about an axis of rotation relative to a stator of the electric drive motor during operation. In the present case, the rotor 12 comprises a rotor main body 18, at each of the end faces of which a balance washer 20 is arranged.

In FIGS. 1 and 2, the rotor shaft 14 is shown in two different embodiments. In this case, a common feature of the two embodiments is that the rotor shaft 14 comprises a hollow shaft 22, which radially encloses a cavity 24. Furthermore, the rotor shaft 14 comprises a hollow lance 26, which is arranged in the cavity 24 and is fastened at both ends to the inside of the hollow shaft 22. In this case, provision is made for the lance 26 to be held at both ends against the inside of the hollow shaft 22 in each case via a press fit 28. As is particularly readily apparent from FIGS. 1 and 2, provision is made, in both embodiments, for the lance 26 to be open at a first end 30, with the result that coolant 32 can flow via this first end 30 into a lance volume 34 enclosed by the lance 26. Furthermore, provision is made for the lance 26 to be closed at its second end 36 opposite to the first end 30. The coolant 32 is thus prevented from flowing into the lance volume 34 or out of the lance volume 34 via the second end 36. Instead, the lance 26 has, in its circumferential wall 38, at least one opening 40, through which the coolant 32 can flow out of the lance volume 34 into a region 42 of the cavity 24 which is delimited radially outwardly by the hollow shaft 22 and radially inwardly or radially toward the axis of rotation of the rotor shaft 14 by the lance 26, in particular the circumferential wall 38 of the lance 26. In the present case, provision is made for the lance 26 to have, in its circumferential wall 38, at least two openings 40, through which the coolant 32 can flow into the region 42 of the cavity 24. In both configurations of the rotor shaft 14, provision is made for the lance 26 to have a cross-sectional narrowing 44 downstream of the at least one opening 40 in the direction of flow of the coolant 32 through the lance volume 34.In FIGS. 1 and 2, the rotor shaft 14 is shown in two different embodiments. In this case, a common feature of the two embodiments is that the rotor shaft 14 comprises a hollow shaft 22, which radially encloses a cavity 24. Furthermore, the rotor shaft 14 comprises a hollow lance 26, which is arranged in the cavity 24 and is fastened at both ends to the inside of the hollow shaft 22. In this case, provision is made for the lance 26 to be held at both ends against the inside of the hollow shaft 22 in each case via a press fit 28. As is particularly readily apparent from FIGS. 1 and 2, provision is made, in both embodiments, for the lance 26 to be open at a first end 30, with the result that coolant 32 can flow via this first end 30 into a lance volume 34 enclosed by the lance 26. Furthermore, provision is made for the lance 26 to be closed at its second end 36 opposite to the first end 30. The coolant 32 is thus prevented from flowing into the lance volume 34 or out of the lance volume 34 via the second end 36. Instead, the lance 26 has, in its circumferential wall 38, at least one opening 40, through which the coolant 32 can flow out of the lance volume 34 into a region 42 of the cavity 24 which is delimited radially outwardly by the hollow shaft 22 and radially inwardly or radially toward the axis of rotation of the rotor shaft 14 by the lance 26, in particular the circumferential wall 38 of the lance 26. In the present case, provision is made for the lance 26 to have, in its circumferential wall 38, at least two openings 40, through which the coolant 32 can flow into the region 42 of the cavity 24. In both configurations of the rotor shaft 14, provision is made for the lance 26 to have a cross-sectional narrowing 44 downstream of the at least one opening 40 in the direction of flow of the coolant 32 through the lance volume 34.

As is furthermore particularly readily apparent from FIGS. 1 and 2, provision is made for the openings 40 in the lance 26 to be arranged, in the present case, so as to radially overlap a region of the hollow shaft 22 which is overlapped radially outwardly by an axial center of the rotor 12. In other words, the rotor 12 can be cooled particularly readily in its center, arranged with respect to the axial direction, in that the coolant 32 flowing out of the openings 40 flows directly against the region of the hollow shaft 22 that radially inwardly overlaps this region of the rotor 12. The coolant 32 flowing in the region 42 can flow along a wall, radially outwardly delimiting the cavity 24, of the hollow shaft 22 to respective outflow openings 46, through which the coolant 32 can flow out of the cavity 24. Once the coolant 32 has flowed out of the cavity 24 through the outflow openings 46, this coolant 32 can flow through at least one of the balance washers 20 in order to cool this balance washer 20.

In the configuration of the rotor shaft 14 shown in FIG. 1, provision is made for the hollow shaft 22 to have an internal toothing 48, via which the hollow shaft 22 can mesh with the transmission input shaft 16. As is furthermore apparent from FIG. 1, provision is made for the lance 26 to bear against the internal toothing 48, in particular to form the press fit 28 with the internal toothing 48. As a result, the lance 26 is held at one end with its first end 30 against the hollow shaft 22 via the internal toothing 48. Furthermore, in the configuration shown in FIG. 1, provision is made for the rotor shaft 14 to comprise a sealing ring 50, which is an O-ring in the present case. The sealing ring 50 fully overlaps all the gaps between the teeth of the internal toothing 48 in the axial direction A toward the second end 36 of the lance 26. Furthermore, the sealing ring 50 bears with its radially inner side radially outwardly against the lance 26. As a result, the coolant 32 is prevented from flowing along the outer side of the lance 26 through the gaps between the teeth of the internal toothing 48 and into the region 42 of the cavity 24.

In the embodiment shown in FIG. 2, provision is made for the hollow shaft 22 to have, at one of its ends, an external toothing 52, via which the hollow shaft 22 meshes with the transmission input shaft 16. In this case, provision is made for the lance 26 to radially inwardly overlap the external toothing 52 in a longitudinal portion extending in the axial direction A. The radial direction R is perpendicular to the axial direction A. The axial direction A extends parallel to a direction of longitudinal extension of the axis of rotation of the rotor shaft 14.

The present disclosure is based on the finding that, in the development of electric drive motors, the cooling of laminated stator cores and laminated rotor cores is becoming increasingly important. Effective cooling makes it possible to optimize the electric drive motor in terms of continuous output, weight and efficiency.

In order to ensure uniform cooling of an A side and a B side of the rotor 12, as far as possible symmetric distribution of the coolant 32 in the rotor shaft 14 should be ensured. For this purpose, in the present case use is made in the rotor shaft 14 of the lance 26, which is in the form of a thin-walled sleeve in the present case and has been pressed into the hollow shaft 22. In the present case, the lance 26 is a centrally perforated metal sleeve, which has been fixed in the hollow shaft 22 by a press fit. The lance 26 has, level with the center of the rotor 12, in particular the center of a laminated core of the rotor 12, a plurality of openings 40, which are in the form of outlet holes in the present case and allow a symmetric distribution of the coolant 32. In the present case, provision is made for oil to be used as the coolant 32. The coolant 32 exiting the rotor shaft 14 can be conducted through the balance washers 20 present there, through which the coolant 32 is either used directly for cooling stator end windings or can be used, by a specific channel guide through the laminated rotor core, to cool magnets of the rotor 12.

If the hollow shaft 22 has the internal toothing 48 for torque transmission with the transmission input shaft 16, the lance 26 is pressed into the tip circle diameter of the internal toothing 48 with its first end 30. With its second end 36, the lance 26 can be pressed into a defined hole in the hollow shaft 22. Alternatively, the lance 26 can be mounted in the hollow shaft 22 at its second end 36 by an O-ring. It is possible for the lance 26 to be made from a plastic. For oil sealing in the region of the internal toothing 48, a clearance can be used, in which the sealing ring 50 is arranged.

If, as shown in FIG. 2, the hollow shaft 22 has the external toothing 52 for torque transmission to the transmission input shaft 16, the lance 26 is pressed with its second end 36 into the defined hole in the hollow shaft 22 and with its first end 30 into an inlet of the hollow shaft 22.

As a whole, the present disclosure describes how the rotor shaft 14 with an integrated lance sleeve, and thus with the lance 26, can be implemented.

The foregoing disclosure has been set forth merely to illustrate the present disclosure and is not intended to be limiting. Since modifications of the disclosed embodiments incorporating the spirit and substance of the present disclosure may occur to persons skilled in the art, the invention should be construed to include everything within the scope of the appended claims and equivalents thereof.

### LIST OF REFERENCE SIGNS

10 Arrangement

12 Rotor

14 Rotor shaft

16 Transmission input shaft

18 Rotor main body

20 Balance washer

22 Hollow shaft

24 Cavity

26 Lance

28 Press fit

30 First end

32 Coolant

34 Lance volume

36 Second end

38 Circumferential wall

40 Opening

42 Region

44 Narrowing

46 Outflow opening

48 Internal toothing

50 Sealing ring

52 External toothing

A Axial direction

R Radial direction

What is claimed is:

1. A rotor shaft for an electric drive motor, the rotor shaft comprising:
a hollow shaft that radially encloses a cavity; and
a hollow lance that is arranged in the cavity and is fastened at both ends of the hollow lance to an inside of the hollow shaft, wherein the hollow lance comprises in its circumferential wall, at least one opening configured to allow a coolant to flow therethrough from the lance into a region of the cavity that is delimited radially outwardly by the hollow shaft and radially inwardly by the lance.

2. The rotor shaft according to claim 1,
wherein the lance is open at a first end such that, via the first end, the coolant can flow into a lance volume enclosed by the lance, and the lance is closed at its second end opposite to the first end.

3. The rotor shaft according to claim 1,
wherein the lance is held at both ends against the inside of the hollow shaft via a press fit.

4. The rotor shaft according to claim 1,
wherein the hollow shaft comprises, at one of its ends, an external toothing, via which the hollow shaft is configured to mesh with a transmission input shaft, and wherein the lance overlaps the external toothing radially inwardly in a longitudinal portion.

5. The rotor shaft according to claim 1,
wherein the hollow shaft comprises, at a first ends, an internal toothing, via which the hollow shaft is configured to mesh with a transmission input shaft, and wherein the lance is configured to bear against the internal toothing in a longitudinal portion, such that the lance is held at the one end against the hollow shaft via the internal toothing.

6. The rotor shaft according to claim 5,
wherein the lance is held by the first end against the hollow shaft via the internal toothing, and wherein a sealing ring is provided that fully overlaps gaps between teeth of the internal toothing in an axial direction toward a second end of the lance and is configured to bear against the lance radially outwardly with its radially inner side, such that any flow of the coolant along an outer side of the lance through the gaps between the teeth of the internal toothing and into the region of the cavity which is delimited radially outwardly by the hollow shaft and radially inwardly by the lance is prevented.

7. The rotor shaft according to claim 1,
wherein the rotor shaft is used in the electric drive motor, and
wherein the at least one opening in the lance is arranged so as to radially overlap a region of the hollow shaft which is overlapped radially outwardly by an axial center of a rotor.

8. The rotor shaft according to claim 1,
wherein the lance comprises a cross-sectional narrowing downstream of the at least one opening in a direction of flow of the coolant through the lance.

9. An electric drive motor comprising:
a stator;
a rotor that is rotatable about an axis of rotation relative to the stator; and
the rotor shaft according to claim 1, on which the rotor is fitted for conjoint rotation.

10. A motor vehicle comprising:
the electric drive motor according to claim 9.
